(19) United States
(12) Patent Application Publication
(10) Pub. No.: US 2014/0006859 A1
(43) Pub. Date: Jan. 2, 2014

(54) STORAGE SYSTEM AND DATA MANAGING METHOD THEREOF

(71) Applicant: SAMSUNG ELECTRONICS CO., LTD., Suwon-Si (KR)

(72) Inventor: JUN KIL RYU, SEONGNAM-SI (KR)

(73) Assignee: SAMSUNG ELECTRONICS CO., LTD., SUWON-SI (KR)

(21) Appl. No.: 13/776,793

(22) Filed: Feb. 26, 2013

(30) Foreign Application Priority Data
Jun. 27, 2012 (KR) 10-2012-0069367

(51) Int. Cl. G06F 11/10

(52) U.S. Cl. CPC G06F 11/106
USPC 714/21

(57) ABSTRACT

A method is provided for managing data of a storage system. The data managing method includes storing write data transferred from a host in a storage device, and performing a scrubbing operation for verifying validity of the stored write data by the storage device in response to a scrubbing command from the host. The scrubbing command includes a validity verification period of the scrubbing operation.

### CROSS-REFERENCE TO RELATED APPLICATIONS

A claim for priority under 35 U.S.C. §119 is made to Korean Patent Application No. 10-2012-0069367, filed Jun. 27, 2012, in the Korean Intellectual Property Office, the entire contents of which are hereby incorporated by reference.

### BACKGROUND

Embodiments of the inventive concept described herein relate to a storage system and a data managing method, and more particularly, relate to a storage system including a nonvolatile memory and a data managing method thereof.

A solid state disk (SSD) may be used as a storage device using a nonvolatile memory. The SSD may be configured to transfer data in parallel using multiple channels. The channels may be used independently. One channel may include multiple memory banks, and the SSD may increase throughput of data using the memory banks.

In a storage system, the SSD may store write data by interfacing with a host. If a write operation is performed abnormally or data is lost during the write operation, write data stored in the SSD may be damaged. To prevent the above-described problems, the host may verify write data stored at the SSD periodically. If the write data is damaged, the write data may be again written in the SSD. This operation may be referred to as a data scrubbing operation. However, with conventional data scrubbing, the host may periodically read data stored in the SSD, which may cause overload of a storage system including the host.

### SUMMARY

Exemplary embodiments of the inventive concept provide a method for managing data of a storage system. The data managing method includes storing write data transferred from a host in a storage device, and performing a scrubbing operation for verifying validity of the stored write data by the storage device in response to a scrubbing command from the host. The scrubbing command includes a validity verification period of the scrubbing operation.

Performing the scrubbing operation may include reading the stored write data according to the scrubbing command, generating second hash data from the read write data, and comparing the second hash data with first hash data previously stored to determine the validity of the stored write data. The first hash data may be generated from the write data when the write data is stored.

The scrubbing command may further include a validity verification range of the stored write data. The validity verification range may include a logical address indicating at least one part of the stored write data.

The second hash data may be generated newly every validity verification period. Reading the stored write data may include determining whether to perform a read operation in which at least a part of the stored write data is read during the validity verification period, and reading the at least a part of the stored write data from a nonvolatile memory according to the determination result.

The read operation may be performed as a part of an internal read operation. The internal read operation may include one of a merge operation, a garbage collection operation, or a read refresh operation.

The method may further include providing a validity determination result to the host, the validity determination result indicating the validity of the stored write data. The method may further include resending write data from the host to the storage device according to the validity determination result.

Exemplary embodiments of the inventive concept also provide a storage system including a host and a storage device. The host is configured to provide write data and a scrubbing command on the write data. The storage device includes a nonvolatile memory to store the write data, the storage device being configured to verify validity of the stored write data in response to the scrubbing command and to provide a validity determination result, indicating the validity of the stored write data, to the host.

The storage device may be further configured to read the stored write data, to generate second hash data, and to compare the second hash data with previously stored first hash data for verifying of the validity of the stored write data.

The storage device may further include a cache memory configured to temporarily store the stored write data for generation of the second hash data, and a controller configured to control the nonvolatile memory and the cache memory and to generate the second hash data from the write data stored at the cache memory.

The storage may be a solid state disk.

Exemplary embodiments of the inventive concept also provide a storage device including an interface, a controller and a memory device. The interface is configured to interface with a host. The controller is configured to receive write data and a scrubbing command from the host via the interface. The memory device is configured to store the write data. The controller is further configured to verify validity of the stored write data in response to the scrubbing command, the scrubbing command comprising at least one of a validity verification period and a validity verification range, and to provide a validity determination result, indicating the validity of the stored write data, to the host via the interface.

The memory device may include nonvolatile memory configured to store primary hash data, generated from previously received original write data, and cache memory configured to temporarily store the stored write data. The controller may be further configured to generate new hash data from the temporarily stored write data, to load the primary hash data into the cache, and to compare the new hash data to the primary hash data to provide the validity determination result.

The nonvolatile memory may store the primary hash data as metadata associated with the original write data.

The controller may determine that the stored write data is valid when the new hash data is the same as the primary hash data, and the controller may determine that the stored write data is invalid when the new hash data is different from the primary hash data.

### BRIEF DESCRIPTION OF THE FIGURES

Illustrative embodiments will be more clearly understood from the following detailed description taken in conjunction with the accompanying drawings, in which like reference numerals refer to like parts throughout the various figures unless otherwise specified.

FIG. 1 is a block diagram schematically illustrating a storage system, according to an embodiment of the inventive concept.

FIG. 2 is a diagram illustrating an interface of a storage system, according to an embodiment of the inventive concept.

FIG. 3 is block diagrams illustrating operations of a storage system, according to an embodiment of the inventive concept.

FIG. 4 is block diagrams illustrating operations of a storage system, according to an embodiment of the inventive concept.

FIG. 5 is block diagrams illustrating operations of a storage system, according to an embodiment of the inventive concept.

FIG. 6 is block diagrams illustrating operations of a storage system, according to an embodiment of the inventive concept.

FIG. 7 is a flow chart illustrating a data managing method of a storage system, according to an embodiment of the inventive concept.

FIG. 8 is a flow chart illustrating operation S120 of FIG. 7, according to an embodiment of the inventive concept.

FIG. 9 is a block diagram schematically illustrating an SSD controller, according to embodiments of the inventive concept.

FIG. 10 is a block diagram schematically illustrating an electronic device including a storage system, according to embodiments of the inventive concept.

FIG. 11 is a block diagram schematically illustrating flash memory applied to a storage system, according to embodiments of the inventive concept.

FIG. 12 is a perspective view schematically illustrating a 3D structure of a memory block illustrated in FIG. 11, according to embodiments of the inventive concept.

FIG. 13 is a circuit diagram schematically illustrating an equivalent circuit of a memory block illustrated in FIG. 12, according to embodiments of the inventive concept.

### DETAILED DESCRIPTION

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the drawings, the sizes and relative sizes of layers and regions may be exaggerated for clarity.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

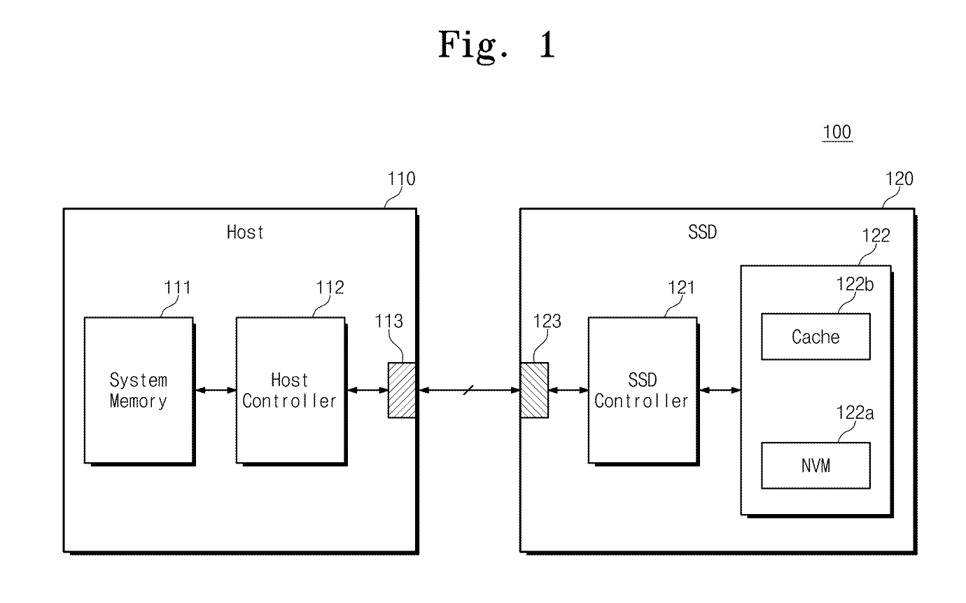

FIG. 1 is a block diagram schematically illustrating a storage system according to an embodiment of the inventive concept. Referring to FIG. 1, a storage system 100 includes a host 110 and an SSD 120. The host 110 includes a system memory 111, a host controller 112, and a host interface 113. The host 110 interfaces with the SSD 120, and is configured to write data at the SSD 120 and/or read data from the SSD 120. The host controller 112 sends signals (e.g., a command, an address, a control signal, etc.) to the SSD 120 via the host interface 113. The system memory 111 may be a main memory.

The SSD 120 includes an SSD controller 121, an SSD memory 122, and an SSD interface 123. The SSD 120 exchanges signals with the host 110 via the SSD interface 123. The SSD memory 122 includes nonvolatile memory (NVM) 122a and cache memory 122b. The SSD controller 121 controls the SSD memory 122 and the SSD interface 123.

In exemplary embodiments, the SSD 120 may be supplied with power from the host 110 via a power connector (not shown). The SSD 120 may further comprise an auxiliary power supply (not shown).

The nonvolatile memory 122a may include multiple memories. For example, the nonvolatile memory 122a may be implemented by NAND flash memory, phase-change random access memory (PRAM), magnetic random access memory (MRAM), resistive random access memory (ReRAM), ferroelectric random access memory (FRAM), and the like. The nonvolatile memory 122a may be used as a storage medium. If the nonvolatile memory 122a includes multiple memories, it may be connected to the SSD controller 121 via multiple channels. One channel may be connected to one or more memories. Memories connected to one channel may be connected to the same bus.

The cache memory 122b may be a system memory or a driving memory of the SSD 120, for example. Data required when the SSD controller 121 performs an operation may be loaded and stored in the cache memory 122b. For example, the cache memory 122b may be implemented by a static random access memory (SRAM), a dynamic random access memory (DRAM), or a combination of SRAM and DRAM.

The SSD controller 121 exchanges signals with the host 110 via the host interface 123. Herein, the signals may include a command, an address, data, and the like. The SSD controller 121 writes and/or reads data to and/or from the SSD memory 122.

In the storage system 100, the host 110 stores write data in the SSD 120. The host 110 also may send a scrubbing command to the SSD 120 for performing a scrubbing operation (or, validity verification operation) on data stored in the SSD 120. In accordance with the scrubbing command, the SSD 120 verifies the validity of (or, scrubs) the stored data. In response to the scrubbing command, the host 110 determines a range of write data to be scrubbed and/or a period for performing the scrubbing operation, referred to as a validity verification range and a validity verification period, respectively. In exemplary embodiments, the scrubbing command may include logical address(es) indicating the validity verification range of write data to be scrubbed.

The SSD 120 performs a scrubbing operation using a secure hash algorithm to verify the validity of data. For example, the SSD 120 may generate primary hash data (or first hash data) based on original write data, and store the primary hash data as metadata. In a scrubbing operation, the SSD 120 reads write data to generate new hash data (or second hash data) on the read write data. The new hash data is compared to the primary hash data, generated from previously received original write data. If the new hash data is the same as the primary hash data, the stored write data is data that is not damaged. If the new hash data is different from the primary hash data, the stored write data is determined to be damaged data. Secure hash algorithms are well known in the art, and thus a description thereof is omitted. The determination of whether the stored write data is damaged may be referred to as a validity determination result (or, a scrubbing result).

In the event that the validity determination result indicates that the data is damaged, the SSD 120 reports the validity determination result to the host 110. The SSD 120 may store the validity determination result in the nonvolatile memory 122a, and may send the stored validity determination result to the host 110 in response to a request from the host 110, for example.

According to the above description, the SSD 120 internally performs a hash data generating operation, a write data reading operation, and the like, associated with the scrubbing operation. The host 110 provides the scrubbing command to the SSD 120 and receives a validity determination result associated with stored data. Thus, it is possible to reduce the burden/load on the host 110.

As described further below, the SSD 120 may perform an internal read operation in which stored data is read via a merge operation, a garbage collection operation, or a read refresh operation, for example. The SSD 120 may use data read via the internal read operation for the scrubbing operation. For example, the SSD 120 may avoid reading data separately for the scrubbing operation by scrubbing data in connection with an internal read operation. This reduces the number of read operations executed to read the write data from the nonvolatile memory 122a, and thus improves the endurance and reliability of the nonvolatile memory 122a and a scrubbing speed of the scrubbing operation. In other words, the endurance and reliability of the storage system 100 may be improved.

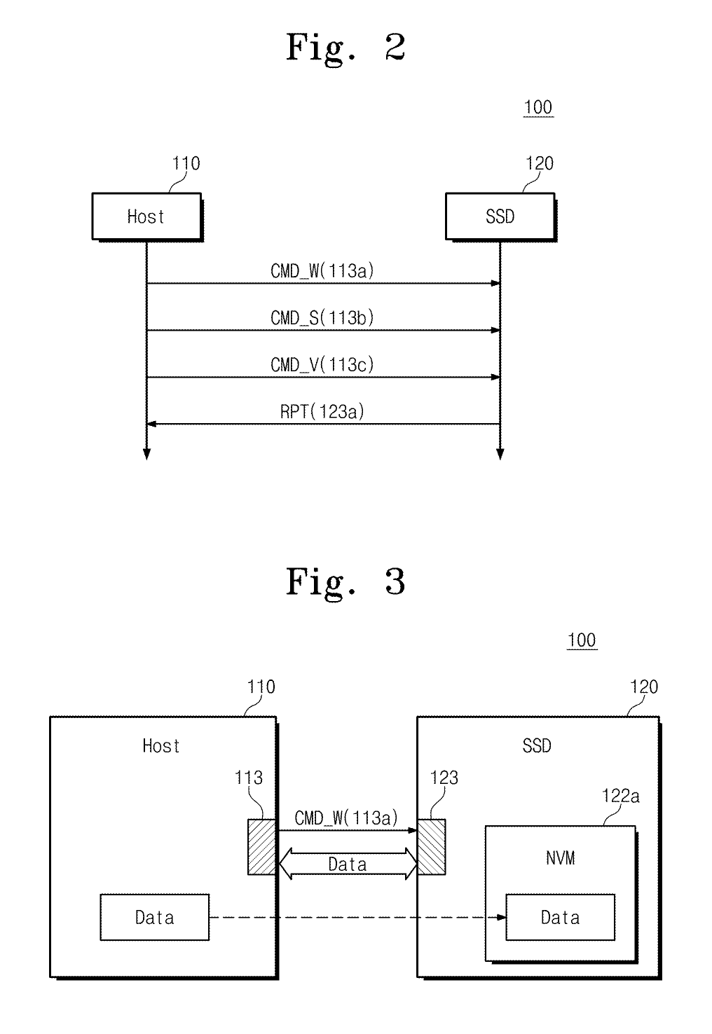

FIG. 2 is a diagram illustrating an interface of the storage system, according to an embodiment of the inventive concept. Referring to FIG. 2, the storage system 100 includes the host 110 and the SSD 120. The host 110 and the SSD 120 are configured to communicate with each other via interfaces 113 and 123 (refer to FIG. 1).

In the depicted embodiment, the host 110 sends a data write command CMD_W(113a) to the SSD 120. At this time, the host 110 may send write data to the SSD 120 together with the data write command CMD_W(113a). Alternatively, the host 110 may send the write data to the SSD 120 before or after the transfer of the data write command CMD_W(113a).

The SSD 120 stores the write data in a nonvolatile memory 122a (refer to FIG. 1) in response to the data write command CMD_W(113a). If the write data is stored in the SSD 120, the host 110 sends a scrubbing command CMD_S(113b) to the SSD 120. The scrubbing command CMD_S(113b) enables the SSD 120 to verify whether stored write data is damaged. In FIG. 2, there is illustrated an example in which the scrubbing command CMD_S(113b) is sent after write data is stored in the SSD 120. However, the inventive concept is not limited thereto. For example, the scrubbing command CMD_S(113b) may be transferred at the same time or substantially the same time as the data write command CMD_W(113a).

In exemplary embodiments, the scrubbing command CMD_S(113b) includes a validity verification range of stored write data or a validity verification period. With the scrubbing command CMD_S(113b), it is possible to determine a part of stored write data to verify the validity of data (or, to verify whether data is damaged). At this time, a validity verification range of data, the validity of which is to be verified, may be appointed by a logical address of stored write data. Also, with the scrubbing command CMD_S(113b), the SSD 120 may periodically verify whether data is damaged. In exemplary embodiments, the SSD 120 may store a validity determination result result in the nonvolatile memory 122a.

The host 110 sends a confirmation request CMD_V(113c) to the SSD 120. The SSD 120 provides the host 110 with a verification report RPT(123a) in response to the confirmation request CMD_V(113c). In exemplary embodiments, the SSD 120 may provide the host 110 with the verification report CMD_V(113c) immediately once damage of stored data is detected, regardless of the confirmation request CMD_V(113c). In exemplary embodiments, if the confirmation request CMD_V(113c) is received, the SSD 120 verifies the validity of newly stored data to provide a result as the verification report RPT(123a).

According to the above description, a scrubbing interface may be provided between a host and a storage device. Also, since a scrubbing operation is performed within the SSD 120, the burden/load of the host 110 is reduced. Further, the endurance and reliability of the storage system is improved.

FIGS. 3 to 6 are block diagrams illustrating a storage system according to an embodiment of the inventive concept. In FIGS. 3 to 6, there are illustrated operations of a storage system to which an interface described with reference to FIG. 2 is applied.

Referring to FIG. 3, the host 110 sends a data write command CMD_W(113a) to the SSD 120 via the host interface 113. The SSD 120 receives the data write command CMD_W(113a) via the SSD interface 123. The host 110 also sends write data to the SSD 120 via the host interface 113. The SSD 120 receives the write data via the SSD interface 123. The SSD 120 stores the write data in the nonvolatile memory 122a in response to the data write command CMD_W(113a).

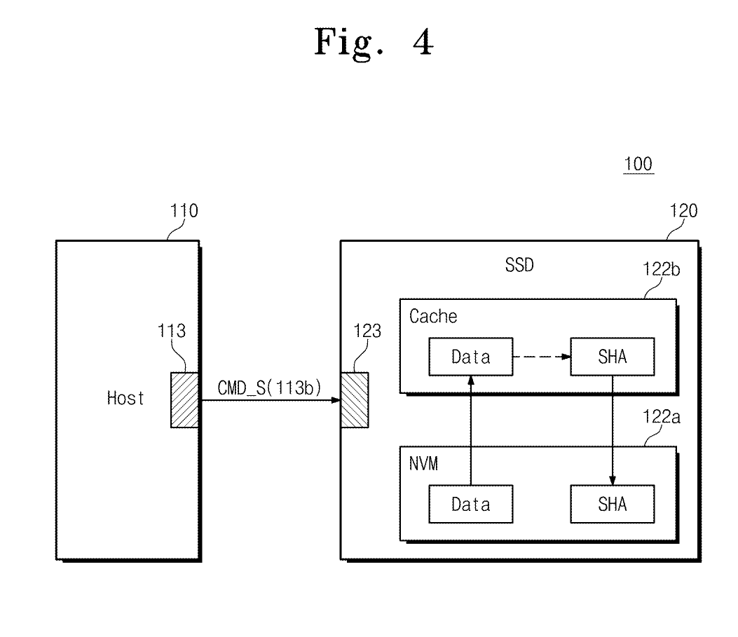

Referring to FIG. 4, the host 110 sends a scrubbing command CMD_S(113b) to the SSD 120. The SSD 120 reads write data stored in the nonvolatile memory 122a in response to the scrubbing command CMD_S(113b). The read write data is loaded into the cache memory 122b. The SSD controller 121 (refer to FIG. 1) generates hash data SHA from the write data loaded onto the cache memory 122b according to the secure hash algorithm. At this time, if the generated hash data SHA is primary hash data on the write data, it is stored in the nonvolatile memory 122a.

Notably, the inventive concept is not limited to the SSD 120 generating primary hash data in response to the scrubbing command CMD_S(113b), as described in the example above. For example, the SSD 120 may generate primary hash data from the write data when the write data is received from the host 110 (refer to FIG. 3). In exemplary embodiments, the stored hash data SHA may be managed as metadata on the write data.

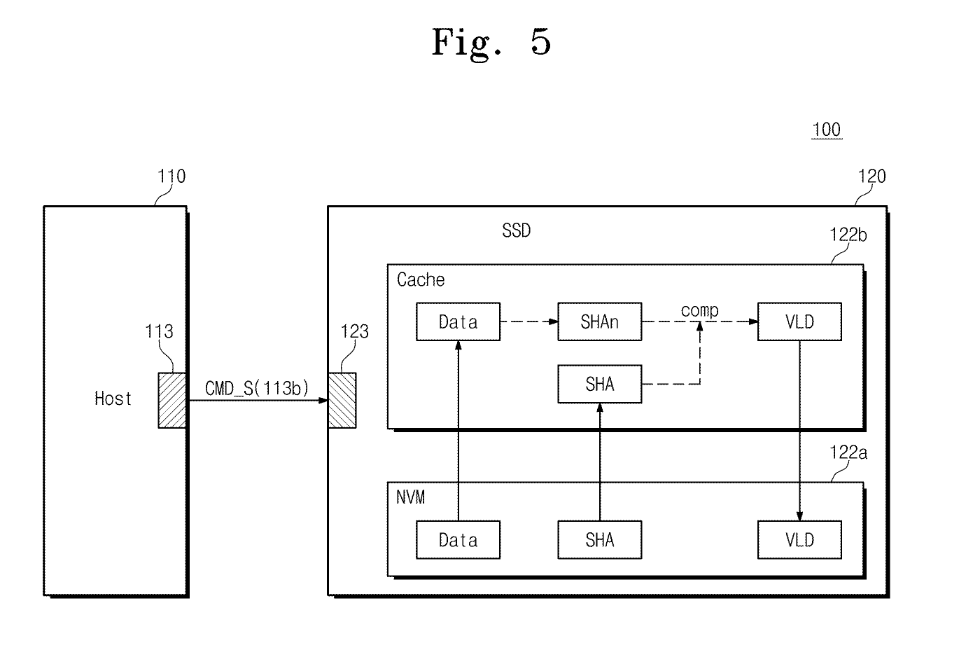

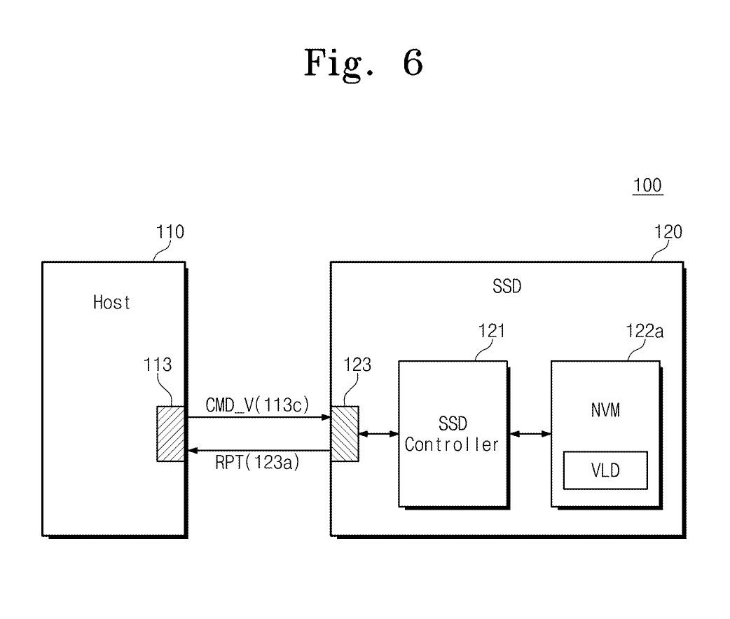

In FIG. 5, there is illustrated an operation in which primary hash data is stored, and then the validity of stored write data is verified in response to the scrubbing command CMD_S(113b). Referring to FIG. 5, in response to the scrubbing command CMD_S(113b), the SSD 120 reads stored write data to verify the validity of the stored write data.

In exemplary embodiments, the SSD 120 performs a scrubbing operation on stored write data according to a validity verification range and/or a validity verification period included in the scrubbing command CMD_S(113b). The validity verification range and the validity verification period are discussed above.

To verify the validity of stored write data, the SSD 120 reads write data from the nonvolatile memory 122a and loads it into the cache memory 122b. The SSD controller 121 generates new hash data SHAn from the loaded write data according to the secure hash algorithm. The SSD controller 121 loads the primary hash data SHA stored in the nonvolatile memory 122a into the cache memory 122b. The SSD controller 121 compares the primary hash data SHA with the new hash data SHAn, and determines the validity of the stored write data based on the comparison result. For example, if the primary hash data SHA and the new hash data SHAn coincide with (are the same as) each other, the SSD controller 121 determines that the stored write data is not damaged. If the primary hash data SHA and the new hash data SHAn do not coincide with (are different from) each other, the SSD controller 121 determines that the stored write data is damaged.

The SSD controller 121 generates a validity determination result VLD indicating the validity of the stored write data, and stores the validity determination result VLD in the nonvolatile memory 122a. Alternatively, or in addition, the SSD controller 121 may immediately provide the validity determination result VLD indicating validity to the host 110 via the SSD interface 123.

The SSD 120 may perform the above-described scrubbing operation every constant period (the validity verification period) appointed during the scrubbing operation. In this case, the SSD 120 may generate new hash data SHAn of stored write data every scrubbing period and compare the new hash data SHAn with the primary hash data SHA. The SSD 120 may update the validity determination result VLD according to the comparison result every scrubbing period. Further, the SSD 120 may provide the host 110 with the validity determination result VLD updated every scrubbing period.

In exemplary embodiments, the SSD 120 may use an internal read operation, performed as a part of a merge, garbage collection or read refresh operation, for performing the scrubbing operation. In this case, the SSD 120 determines whether an internal read operation is performed to read at least part of write data that is the object of validity verification during the validity verification period. If an internal read operation is performed during the validity verification period, a part or all of write data may be read according to the internal read operation. The SSD 120 may read any remaining write data (other than data read during the internal read operation), if necessary. New hash data SHAn is generated from the read data. The new hash data SHAn may be temporarily stored in the cache memory 122b. If an internal read operation is not performed during the validity verification period, the SSD 120 may read all of the stored write data to generate the new hash data SHAn.

Because the SSD 120 may perform the scrubbing operation in connection with an internal read operation in which stored write data is read, the amount of data to be read for scrubbing may be reduced. Alternatively, data may not be read separately for scrubbing. Accordingly, it is possible to reduce the number of read operations in which write data is read from the nonvolatile memory 122a.

Referring to FIG. 6, the host 110 sends a confirmation request CMD_V(113c) to the SSD 120. The SSD 120 provides a verification report RPT(123a) to the host 110 in response to the confirmation request CMD_V(113c). The verification report RPT(123a) may include a validity determination result VLD. As another example, the verification report RPT(123a) may include one or more of the primary hash data SHA and the new hash data SHAn.

In exemplary embodiments, the SSD 120 may provide the verification report RPT(123a) to the host 110 immediately when damage of stored data is detected, regardless of the confirmation request CMD_V(113c). In exemplary embodiments, if the confirmation request CMD_V(113c) is received, the SSD 120 may verify the validity of newly stored data to provide a validity determination result as the verification report RPT(123a).

According to various embodiments, scrubbing-associated operations (e.g., generating hash data and reading write data) are performed within the SSD 120. The host 110 simply provides the scrubbing command to the SSD 120 and receives the validity determination result of stored data from the SSD 120. Thus, the burden/load of the host 110 is reduced.

Also, the SSD 120 may perform scrubbing in connection with an internal read operation, so that data for scrubbing need not be read separately. Accordingly, the number of read operations executed to read write data from the nonvolatile memory 122a is reduced, thus improving the endurance, reliability, and scrubbing speed of the storage system 100.

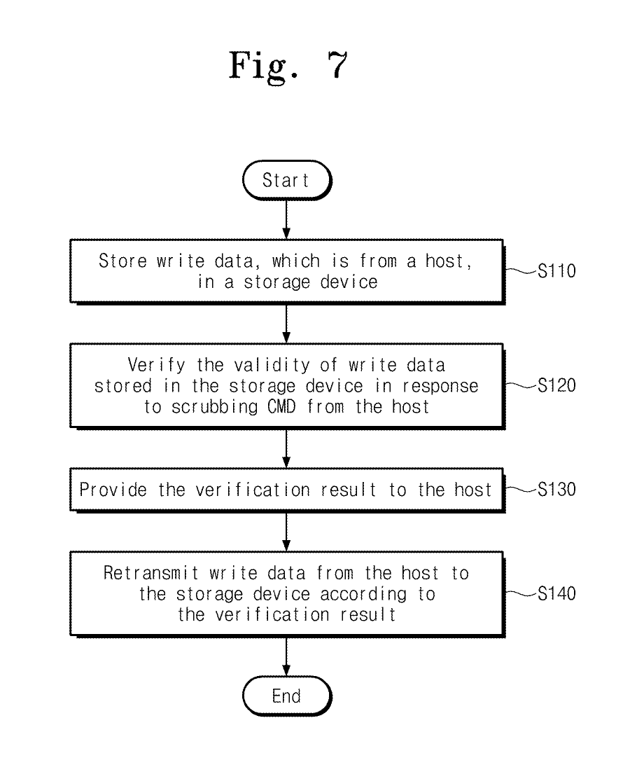

FIG. 7 is a flow chart illustrating a method of managing data of a storage system, according to an embodiment of the inventive concept.

In operation S110, the SSD 120 (refer to FIG. 1) stores write data transferred from a host 110 (refer to FIG. 1). The write data is stored in the nonvolatile memory 122a (refer to FIG. 1). In exemplary embodiments, the nonvolatile memory 122a may be implemented by NAND flash memory, PRAM, MRAM, ReRAM, FRAM, or the like.

In operation S120, the SSD 120 verifies the validity of write data stored in the nonvolatile memory 122a in response to a scrubbing command from the host 110. To verify the validity, the SSD 120 generates new hash data SHAn (refer to FIG. 5) from the stored write data using a secure hash algorithm. The validity of the stored write data is determined by comparing the generated new hash data with primary hash data SHA (refer to FIG. 5), which has been previously determined and stored. Validity verification by the SSD 120 may be made in substantially the same manner as described above.

In operation S130, the SSD 120 provides the host 110 with a validity determination result VLD (refer to FIG. 6) as a verification report RPT(123a). This may be performed in the same manner as described above.

In operation S140, the host 110 determines whether to resend write data to the SSD 120 according to the verification report RPT(123a). For example, if the verification report RPT(123a) indicates that write data stored in the SSD 120 is damaged, the host 110 newly sends the write data to the SSD 120. The write data is sent to the SSD 120 via interfaces 113 and 123 (refer to FIG. 1).

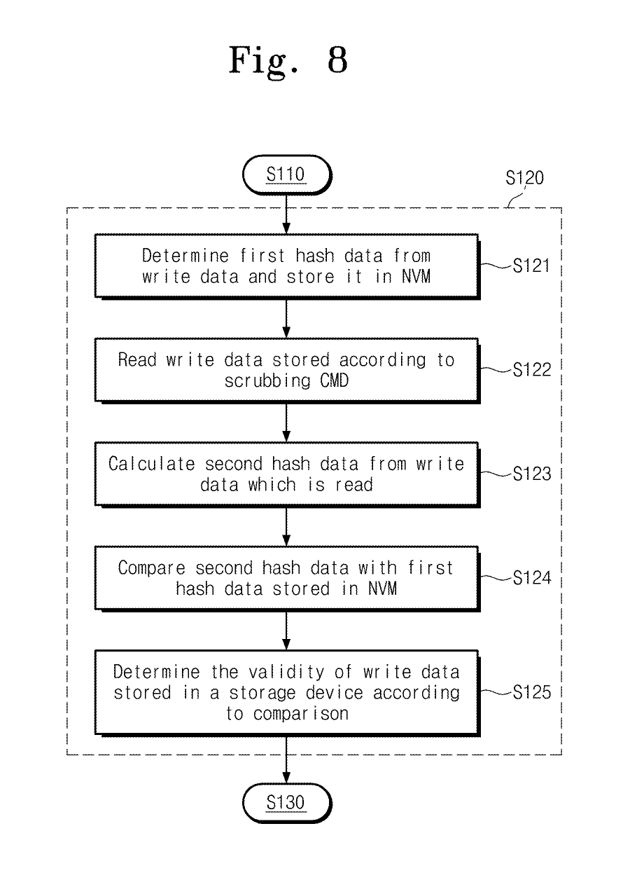

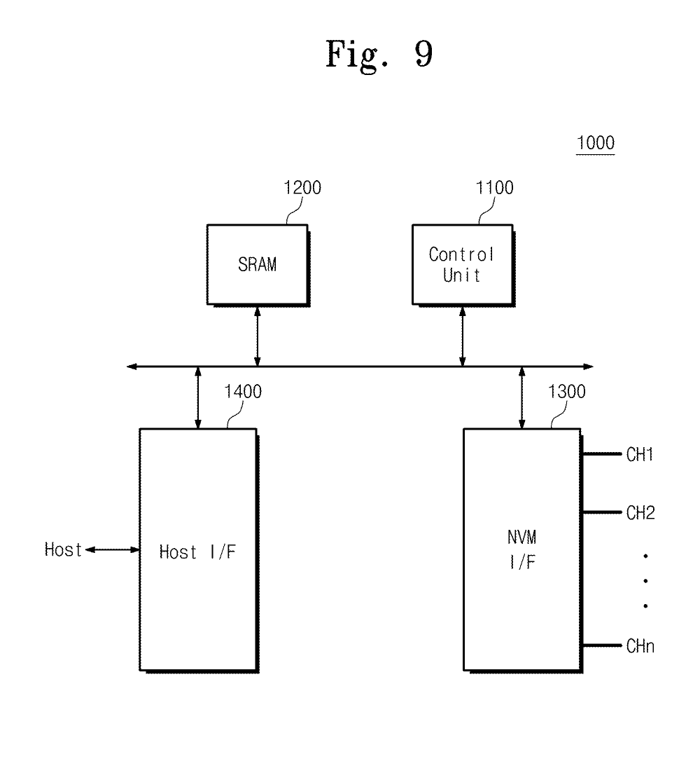

FIG. 8 is a flow chart illustrating operation S120 of FIG. 7, according to an embodiment of the inventive concept.

As discussed above, the SSD 120 (refer to FIG. 1) compares new hash data SHAn (referred to as second hash data) generated from stored write data to previously stored primary hash data SHA (referred to as first hash data). The validity of the stored write data may be verified according to the comparison result.

In operation S121, the SSD 120 initially generates the first hash data from write data and stores the first hash data in the nonvolatile memory 122a. In exemplary embodiments, the first hash data may be generated according to a scrubbing command provided to the SSD 120. In other exemplary embodiments, the first hash data may be generated when the SSD 120 receives write data from a host 110 (refer to FIG. 1).

In operation S122, the SSD 120 reads write data stored in the nonvolatile memory 122a in response to a scrubbing command. The read write data may be loaded onto a cache memory 122b (refer to FIG. 1). In operation S123, the SSD 120 newly calculates hash data (the second hash data) from the write data loaded onto the cache memory 122b. The second hash data generated from the write data may be temporarily stored in the cache memory 122b for comparison with the first hash data.

In operation S124, the SSD 120 compares the second hash data with the first hash data. In operation S125, the SSD 120 determines the validity of the stored write data according to the result of the comparison. For example, if the first hash data and the second hash data coincide with each other, the SSD 120 determines the stored write data to be valid (not damaged). If the first hash data and the second hash data do not coincide with each other, the SSD 120 determines the stored write data to be invalid (damaged).

Scrubbing-associated operations (e.g., generating hash data and reading write data) are performed within the SSD 120. Thus, the burden/load of the host 110 is reduced. Also, the SSD 120 may perform scrubbing in connection with an internal read operation, as discussed above, so that data for scrubbing does not need to be read separately. This reduces the number of read operations executed to read write data from a nonvolatile memory 122a. Accordingly, the endurance, reliability, and scrubbing speed of the storage system 100 are improved.

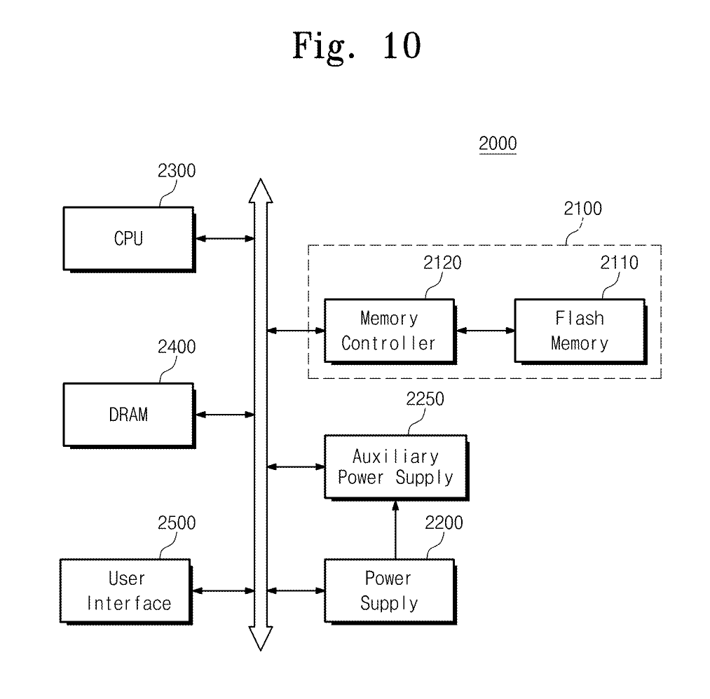

FIG. 9 is a block diagram schematically illustrating an SSD controller, according to an embodiment of the inventive concept. Referring to FIG. 9, an SSD controller 1000 includes a control unit 1100, an NVM interface 1300, a host interface 1400, and a cache memory, indicated as SRAM 1200, for purposes of illustration. The cache memory may be DRAM or SRAM, for example.

The NVM interface 1300 scatters data transferred from a main memory of a host to channels CH1 to CHn, respectively. The NVM interface 1300 may transfer data read from a nonvolatile memory to the host via the host interface 1400.

The host interface 1400 provides an interface with an SSD according to the protocol of the host. The host interface 1400 may communicate with the host using Universal Serial Bus (USB), Small Computer System Interface (SCSI), Peripheral Component interconnect (PCI) express, ATA, Parallel ATA (PATA), Serial ATA (SATA), Serial Attached SCSI (SAS), etc. The host interface 1400 may perform a disk emulation function which enables the host to recognize the SSD as a hard disk drive (HDD).

The control unit 1100 analyzes and processes a signal SGL input from the host. The control unit 1100 may control the host and the nonvolatile memory through the host interface 1400 and the NVM interface 1300, respectively. The control unit 1100 may control the nonvolatile memory according to firmware for driving the SSD.

The SRAM 1200 may be used to drive software which efficiently manages the nonvolatile memory. The SRAM 1200 may store metadata input from a main memory of the host 2100 or cache data. In the even to of a sudden power-off operation, metadata or cache data stored in the SRAM 1200 may be stored in the nonvolatile memory using an auxiliary power supply.

FIG. 10 is a block diagram schematically illustrating an electronic device including a storage system, according to an embodiment of the inventive concept. For example, an electronic device 2000 may be a personal computer or a handheld electronic device, such as a notebook computer, a cellular phone, a PDA, a camera, or the like.

Referring to FIG. 10, the electronic device 2000 include a storage system 2100, a power supply device 2200, an auxiliary power supply 2250, a central processing unit (CPU) 2300, DRAM 2400, and a user interface 2500. The CPU 2300 may correspond to the host in the above-described embodiments. The storage system 2100 includes flash memory 2110 and a memory controller 2120. The storage system 2100 can be embedded within the electronic device 2000.

As described above, the electronic device 2000 provides a scrubbing interface between the storage system 2100 and the CPU 2300, as described above. During a scrubbing operation, the load/burden on the CPU 2300 is thereby reduced. Also, since the read frequency of the nonvolatile memory (herein, the flash memory) is reduced, the endurance and reliability of the storage system including the nonvolatile memory is improved. Accordingly, it is possible to manage data of the storage system efficiently.

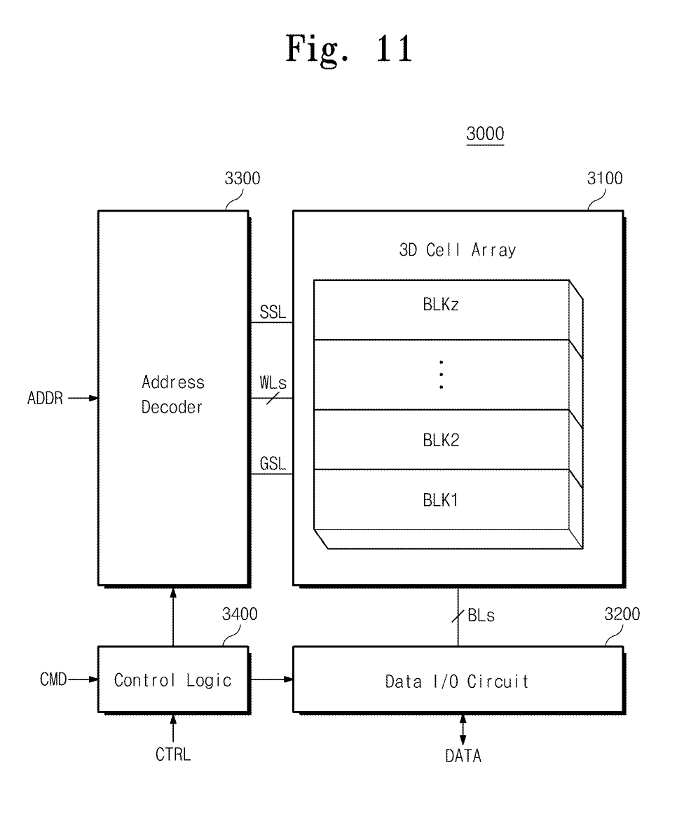

FIG. 11 is a block diagram schematically illustrating flash memory applied to a storage system, according to embodiments of the inventive concept. The storage system may include a three-dimensional flash memory or a two-dimensional flash memory, for example. Referring to FIG. 11, flash memory 3000 includes a three-dimensional (3D) cell array 3100, a data input/output circuit 3200, an address decoder 3300, and control logic 3400.

The 3D cell array 3100 includes multiple memory blocks BLK1 to BLKz, each of which is formed to have a three-dimensional structure (or, a vertical structure). For a memory block having a two-dimensional (horizontal) structure, memory cells may be formed in a direction parallel with a substrate. In comparison, for a memory block having a three-dimensional structure, memory cells may be formed in a direction perpendicular to the substrate. Each of the memory blocks BLK1 to BLKz may be an erase unit of the flash memory 3000.

The data input/output circuit 3200 is connected to the 3D cell array 3100 via multiple bit lines. The data input/output circuit 3200 may receive data from an external device or output data read from the 3D cell array 3100 to the external device. The address decoder 3300 is connected to the 3D cell array 3100 via multiple word lines and selection lines GSL and SSL. The address decoder 3300 may select the word lines in response to an address ADDR.

The control logic 3400 controls programming, erasing, reading, etc., operations of the flash memory 3000. For example, during programming, the control logic 3400 control the address decoder 3300 and the data input/output circuit 3200 such that a program voltage is supplied to a selected word line and data is programmed.

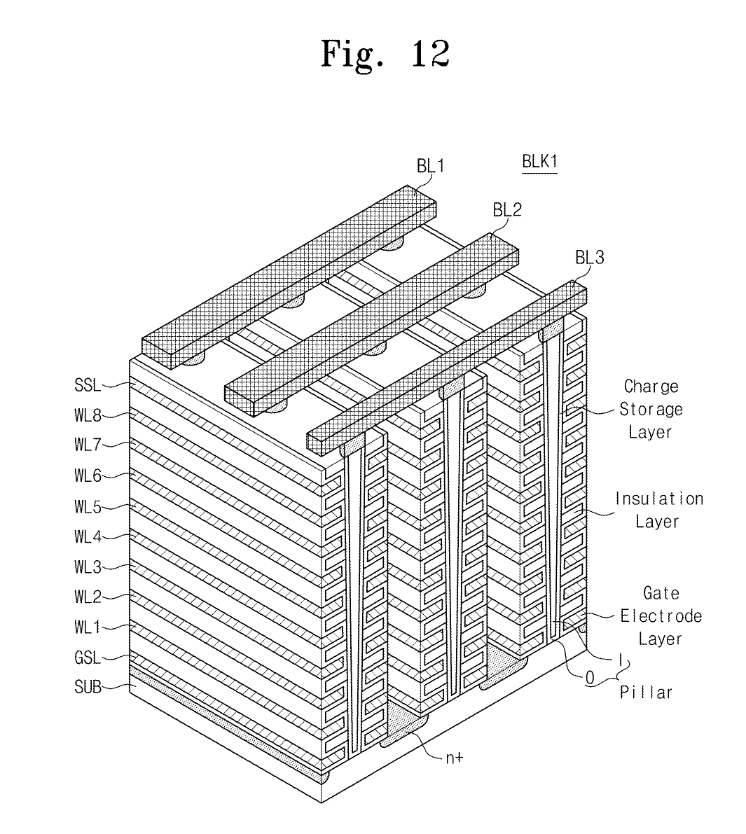

FIG. 12 is a perspective view schematically illustrating a 3D structure of a memory block illustrated in FIG. 11, according to embodiments of the inventive concept. Referring to FIG. 12, a memory block BLK1 is formed in a direction perpendicular to a substrate SUB. An n+ doping region is formed at the substrate SUB. A gate electrode layer and an insulation layer are deposited on the substrate SUB, in turn. A charge storage layer is formed between the gate electrode layer and the insulation layer.

If the gate electrode layer and the insulation layer are patterned in a vertical direction, a V-shaped pillar may be formed. The pillar may be connected to the substrate SUB via the gate electrode layer and the insulation layer. An outer portion O of the pillar may be formed of a channel semiconductor, and an inner portion I thereof may be formed of an insulation material such as silicon oxide.

The gate electrode layer of the memory block BLK1 is connected to a ground selection line GSL, multiple word lines WL1 to WL8, and a string selection line SSL. The pillars of the memory block BLK1 are connected to multiple bit lines BL1 to BL3. In FIG. 12, there is illustrated a case in which one memory block BLK1 has two selection lines SSL and GSL, eight word lines WL1 to WL8, and three bit lines BL1 to BL3. However, the inventive concept is not limited thereto.

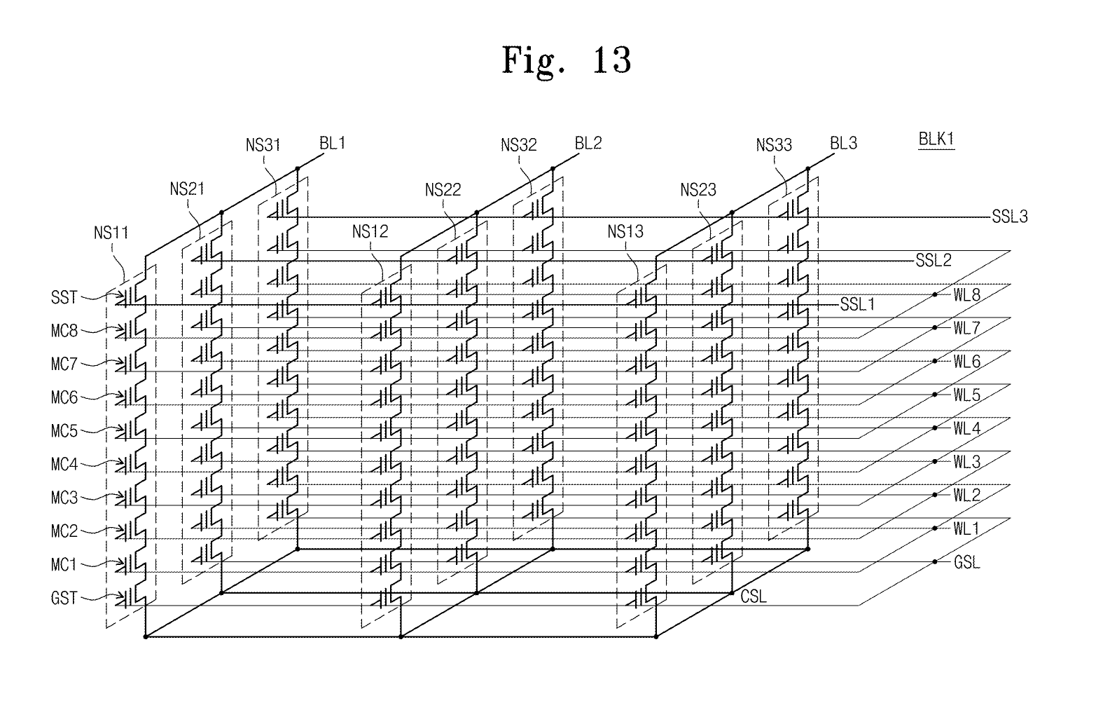

FIG. 13 is a circuit diagram schematically illustrating an equivalent circuit of the memory block illustrated in FIG. 12, according to embodiments of the inventive concept. Referring to FIG. 13, NAND strings NS11 to NS33 are connected between bit lines BL1 to BL3 and a common source line CSL. Each NAND string (e.g., NS11) includes a string selection transistor SST, multiple memory cells MC1 to MC8, and a ground selection transistor GST.

The string selection transistors SST are connected to string selection lines SSL1 to SSL3. The memory cells MC1 to MC8 are connected to corresponding word lines WL1 to WL8, respectively. The ground selection transistors GST are connected to ground selection line GSL. Each string selection transistor SST is also connected to a bit line and each ground selection transistor GST is also connected to a common source line CSL.

Word lines (e.g., WL1) at the same level are connected in common, and the string selection lines SSL1 to SSL3 are separated from one another. During programming of memory cells (constituting a page) connected to a first word line WL1 and included in NAND strings NS11, NS12, and NS13, there may be selected a first word line WL1 and a first string selection line SSL1.

While the inventive concept has been described with reference to exemplary embodiments, it will be apparent to those skilled in the art that various changes and modifications may be made without departing from the spirit and scope of the present inventive concept. Therefore, it should be understood that the above embodiments are not limiting, but illustrative.

What is claimed is:

1. A method of managing data of a storage system, comprising:
storing write data transferred from a host in a storage device; and
performing a scrubbing operation for verifying validity of the stored write data by the storage device in response to a scrubbing command from the host, the scrubbing command comprising a validity verification period of the scrubbing operation.

2. The method of claim 1, wherein performing the scrubbing operation comprises:
reading the stored write data according to the scrubbing command;
generating second hash data from the read write data; and
comparing the second hash data with first hash data previously stored to determine the validity of the stored write data.

3. The method of claim 2, wherein the first hash data is generated from the write data when the write data is stored.

4. The method of claim 2, wherein the scrubbing command further comprises a validity verification range of the stored write data.

5. The data managing method of claim 4, wherein the validity verification range comprises a logical address indicating at least one part of the stored write data.

6. The data managing method of claim 3, wherein the second hash data is generated newly every validity verification period.

7. The method of claim 6, wherein reading the stored write data comprises:
determining whether to perform a read operation in which at least a part of the stored write data is read during the validity verification period; and
reading the at least a part of the stored write data from a nonvolatile memory according to the determination result.

8. The method of claim 7, wherein the read operation is performed as a part of an internal read operation.

9. The method of claim 7, wherein the internal read operation comprises one of a merge operation, a garbage collection operation, or a read refresh operation.

10. The method of claim 1, further comprising:
providing a validity determination result to the host, the validity determination result indicating the validity of the stored write data.

11. The method of claim 10, further comprising:
resending write data from the host to the storage device according to the validity determination result.

12. The method of claim 1, wherein the storage device is a solid state disk.

13. A storage system comprising:
a host configured to provide write data and a scrubbing command on the write data; and
a storage device comprising a nonvolatile memory to store the write data, the storage device being configured to verify validity of the stored write data in response to the scrubbing command and to provide a validity determination result, indicating the validity of the stored write data, to the host.

14. The storage system of claim 13, wherein the storage device is further configured to read the stored write data, to generate second hash data, and to compare the second hash data with previously stored first hash data for verifying of the validity of the stored write data.

15. The storage system of claim 14, wherein the storage device further comprises:
a cache memory configured to temporarily store the stored write data for generation of the second hash data; and
a controller configured to control the nonvolatile memory and the cache memory and to generate the second hash data from the write data stored at the cache memory.

16. The storage system of claim 15, wherein the storage device is a solid state disk.

17. A storage device, comprising:
an interface configured to interface with a host;
a controller configured to receive write data and a scrubbing command from the host via the interface, and
a memory device configured to store the write data,
wherein the controller is further configured to verify validity of the stored write data in response to the scrubbing command, the scrubbing command comprising at least one of a validity verification period and a validity verification range, and to provide a validity determination result, indicating the validity of the stored write data, to the host via the interface.

18. The storage device of claim 17, wherein memory device comprises:
nonvolatile memory configured to store primary hash data, generated from previously received original write data; and
cache memory configured to temporarily store the stored write data,
wherein the controller is further configured to generate new hash data from the temporarily stored write data, to load the primary hash data into the cache, and to compare the new hash data to the primary hash data to provide the validity determination result.

19. The storage device of claim 18, wherein the nonvolatile memory stores the primary hash data as metadata associated with the original write data.

20. The storage device of claim 18, wherein the controller determines that the stored write data is valid when the new hash data is the same as the primary hash data, and the controller determines that the stored write data is invalid when the new hash data is different from the primary hash data.
